(19) United States
(12) Patent Application Publication
(10) Pub. No.: US 2026/0245971 A1
(43) Pub. Date: Aug. 20, 2026

(54) ENERGY STORAGE CELL WITH CYLINDRICAL HOUSING AND METHOD OF MANUFACTURING

(71) Applicant: VARTA Microbattery GmbH, Ellwangen Jagst (DE)

(72) Inventors: Martin ELMER, Ellwangen (DE); Stefan STOCK, Rainau-Dalkingen (DE)

(21) Appl. No.: 18/853,422

(22) PCT Filed: Apr. 6, 2023
(86) PCT No.: PCT/EP2023/059286

§ 371 Date: Oct. 2, 2024

(30) Foreign Application Priority Data
Apr. 6, 2022 (EP) 22166900.5
Jun. 2, 2022 (DE) 10 2022 113 906.9

(51) Int. Cl. H01M 10/0587; H01M 10/0525; H01M 50/107; H01M 50/119; H01M 50/121; H01M 50/152; H01M 50/159; H01M 50/169; H01M 50/179; H01M 50/536

(52) U.S. Cl. CPC H01M 10/0587; H01M 50/107; H01M 50/119; H01M 50/121; H01M 50/152; H01M 50/159; H01M 50/169; H01M 50/179; H01M 50/536; H01M 10/0525

(57) ABSTRACT

An energy storage cell includes a cylindrical housing closed in a liquid-tight manner and having a first housing end face, a second housing end face, and a housing shell. The energy storage cell further includes an electrode-separator assembly in the form of a cylindrical winding formed of electrode ribbons and at least one ribbon-shaped separator. The winding has a first terminal winding end face, a second terminal winding end face, and a winding shell. The electrode-separator assembly is arranged axially in the housing so that the first winding end face points in a direction of the first housing end face and the second winding end face points in a direction of the second housing end face. The housing shell of the energy storage cell is formed of at least one spirally wound foil and comprises at least two layers of the foil.

### CROSS REFERENCE TO RELATED APPLICATIONS

This application is a U.S. National Phase application under 35 U.S.C. § 371 of International Application No. PCT/EP2023/059286, filed on Apr. 6, 2023, and claims benefit to European Patent Application No. EP 22166900.5, filed on Apr. 6, 2022 and to German Patent Application No. DE 10 2022 113 906.9, filed on Jun. 2, 2022. The International Application was published in German on Oct. 12, 2023 as WO 2023/194591 under PCT Article 21(2).

### FIELD

The present disclosure relates to a cylindrical energy storage cell with an electrode-separator assembly in the form of a winding and a method of manufacturing the same.

### BACKGROUND

Electrochemical energy storage elements can convert stored chemical energy into electrical energy through virtue of a redox-reaction. The simplest form of an electrochemical energy storage element is the electrochemical cell. It comprises a positive and a negative electrode, between which a separator is arranged. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current crosses the separator and is made possible by an ion-conducting electrolyte. The separator thus prevents direct contact between the electrodes. At the same time, however, it enables electrical charge equalization between the electrodes.

If the discharge is reversible, i.e. it is possible to reverse the conversion of chemical energy into electrical energy during discharge and charge the cell again, this is said to be a secondary cell. The common designation of the negative electrode as the anode and the designation of the positive electrode as the cathode in secondary cells refers to the discharge function of the electrochemical cell.

Secondary lithium-ion cells are used as energy storage cells for many applications today, as these cells can provide high currents and are characterized by a comparatively high energy density. They are based on the use of lithium, which can migrate back and forth between the electrodes of the cell in the form of ions. The negative electrode and the positive electrode of a lithium-ion cell are generally formed by so-called composite electrodes, which comprise electrochemically inactive components as well as electrochemically active components.

In principle, all materials that can absorb and release lithium ions can be used as electrochemically active components (active materials) for secondary lithium-ion cells. For example, carbon-based particles such as graphitic carbon are used for the negative electrode. Active materials for the positive electrode can be, for example, lithium cobalt oxide (LiCoO₂), lithium manganese oxide (LiMn₂O₄) , lithium iron phosphate (LiFePO₄) or derivatives thereof. The electrochemically active materials are generally contained in the electrodes in particle form.

As electrochemically inactive components, the composite electrodes generally comprise a flat and/or ribbon-shaped current collector, for example a metal foil, which serves as a carrier for the respective active material. The current collector for the negative electrode (anode current collector) can be made of copper or nickel, for example, and the current collector for the positive electrode (cathode current collector) can be made of aluminum, for example. Furthermore, the electrodes can comprise an electrode binder (e.g. polyvinylidene fluoride (PVDF) or another polymer, for example carboxymethyl cellulose), conductivity-improving additives and other additives as electrochemically inactive components. The electrode binder ensures the mechanical stability of the electrodes and often also the adhesion of the active material to the current collectors.

As electrolytes, lithium-ion cells usually comprise solutions of lithium salts such as lithium hexafluorophosphate (LiPF₆) in organic solvents (e.g. ethers and esters of carbonic acid).

The composite electrodes are generally combined with one or more separators to form an electrode-separator assembly when manufacturing a lithium-ion cell. The electrodes and separators are often, but not necessarily, joined together under pressure, possibly by lamination or bonding. The basic functionality of the cell can then be established by impregnating the assembly with the electrolyte.

In many embodiments, the electrode-separator assembly is formed in the form of a winding or processed into a winding. In the first case, for example, a ribbon-shaped positive electrode and a ribbon-shaped negative electrode as well as at least one ribbon-shaped separator are fed separately to a winding machine and spirally wound into a winding with the sequence positive electrode/separator/negative electrode. In the second case, a ribbon-shaped positive electrode and a ribbon-shaped negative electrode as well as at least one ribbon-shaped separator are first combined to form an electrode-separator assembly, for example by applying the aforementioned pressure. In a further step, the assembly is then wound up.

For applications in the automotive sector, for e-bikes or for other applications with high energy requirements, such as in tools, lithium-ion cells with the highest possible energy density are required, which are also able to withstand high currents during charging and discharging.

Cells for the applications mentioned are often designed as cylindrical round cells, for example with a form factor of 21×70 (diameter*height in mm). Cells of this type always comprise an assembly in the form of a winding. Modern lithium-ion cells of this form factor can already achieve an energy density of up to 270 Wh/kg.

WO 2017/215900 A1 describes cylindrical round cells in which the electrode-separator assembly and its electrodes are ribbon-shaped and in the form of a winding. The electrodes each have ribbon-shaped electrodes loaded or coated with electrode material. Oppositely polarized electrodes are arranged offset to each other within the electrode-separator assembly so that longitudinal edges of the current collectors of the positive electrodes protrude from the winding on one side and longitudinal edges of the current collectors of the negative electrodes protrude from the winding on another side. For electrical contacting of the current collectors, the cells have sheet metal parts that sit flat on the end faces of the winding and are welded to the longitudinal edges of the current collectors. This makes it possible to electrically contact the current collectors and thus also the associated electrodes over their entire length. Cells with windings contacted in this way have a significantly reduced internal resistance. As a result, the occurrence of large currents can be absorbed much better and heat can also be dissipated better from the winding.

Electrochemical energy storage cells generally have a metal housing. The housing of cylindrical round cells often comprises a housing cup, which serves as a receptable for the wound electrode-separator assembly, as well as a lid component, which closes the opening of the housing cup. The housing cup can be a deep-drawn component, for example made of aluminum or nickel-plated steel or stainless steel, with a wall thickness in a range from 0.1 mm to 2 mm.

A seal is usually arranged between the lid component and the housing cup, which on the one hand serves to seal the housing, but on the other hand also has the function of electrically insulating the lid component and the housing cup from each other. The seal is usually mounted on the edge of the lid component. To close the round cells, for example, the opening edge of the housing cup can be bent radially inwards over the edge of the lid component enclosed by the seal (crimping process), so that the lid component including the seal is positively fixed in the opening of the housing cup.

To assemble the cells, the electrode-separator assembly must first be produced before the electrode-separator assembly is inserted into the cylindrical and metal housing, which is then sealed, in a separate work step.

In the case of wound electrode-separator assemblies, the electrode winding itself is first produced on a winding machine, then transported to a separate assembly line and inserted into the cup.

Another disadvantage of this procedure is that there often has to be a certain amount of free space or clearance between the outer diameter of the winding and the inner diameter of the cup for the winding to be inserted into the cup. This free space remains unused in the assembled energy storage cell in terms of energy. The relatively high weight of classic housing cups is also detrimental to the energy density of the cell. This can account for up to 15% of the total weight of a cell. Furthermore, classic housing cups made of the metals mentioned are comparatively expensive and, in the case of steel, are often susceptible to rust, especially in the region of the cut edges caused by the manufacturing process. The system technology for feeding and inserting the winding into the cup is also complex and cost-intensive.

### SUMMARY

In an embodiment, the present disclosure provides an energy storage cell. The energy storage cell includes a cylindrical housing closed in a liquid-tight manner, the cylindrical housing comprising a first housing end face, a second housing end face, and a housing shell. The energy storage cell further includes an electrode-separator assembly arranged in the housing, the electrode-separator assembly being in the form of a cylindrical winding formed of electrode ribbons and at least one ribbon-shaped separator. The winding has a first terminal winding end face, a second terminal winding end face, and a winding shell. The electrode-separator assembly is arranged axially in the housing so that the first winding end face points in a direction of the first housing end face and the second winding end face points in a direction of the second housing end face. The housing shell of the energy storage cell is formed of at least one spirally wound foil and comprises at least two layers of the foil.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 provides a longitudinal section through an energy storage cell;

FIG. 2 provides a longitudinal section through a further embodiment of an energy storage cell;

FIG. 3 provides a schematic representation of the components of an electrode-separator assembly;

FIG. 4 provides a schematic representation as a top view of an electrode-separator assembly with a housing shell of an energy storage cell;

FIG. 5 provides schematic longitudinal sectional views (A-C) of further embodiments of an energy storage cell; and

FIG. 6 provides a schematic longitudinal section through a further embodiment of an energy storage cell.

### DETAILED DESCRIPTION

Against this background, the present disclosure provides an improved energy storage cell that allows optimum utilization of its volume. At the same time, the manufacturing process for the cell is to be simplified, thus enabling cost savings in the manufacture of the cells.

The energy storage cell has a cylindrical, liquid-tight sealed housing with a first housing end face and a second housing end face and a housing shell. The energy storage cell comprises the following features:
a. The cylindrical energy storage cell comprises an electrode-separator assembly arranged in the housing;
b. The electrode-separator assembly is in the form of a cylindrical winding formed of electrode ribbons and at least one ribbon-shaped separator, which has a first and a second terminal winding end face and a winding shell;
c. The electrode-separator assembly is arranged axially in the housing so that the first winding end face points in the direction of the first housing end face and the second winding end face points in the direction of the second housing end face.

A core aspect of the disclosure is the following feature:
d. The housing shell of the energy storage cell is formed of at least one spiral-wound foil, preferably a spiral-wound metal foil, and comprises at least two layers of the foil, preferably the metal foil.

The electrode ribbons preferably comprise a ribbon-shaped current collector and a coating of an electrode material arranged thereon.

In particular, the energy storage cell may be a cylindrical round cell. In other embodiments, it can also be a button cell, whereby a button cell differs from a cylindrical round cell in particular in that it is smaller and, in the case of a button cell, the height of the cell is smaller than its diameter.

According to a concept of the present disclosure, the energy storage cell dispenses with a conventional metal housing. Rather, the energy storage cell is characterized by the fact that the housing shell of the cell is formed by wound foil layers, in particular metal foil layers. The foil, in particular the metal foil, is present in at least two layers. In other words, the housing shell is formed of at least two turns of the foil, in particular of the metal foil.

### Housing Shell

Preferably, the housing shell comprises 2 to 50 layers of the foil. Preferred are 2 to 25 layers and most preferably 5 to 25 layers.

The foil, in particular the wound metal foil, preferably has a thickness in a range from 4 to 300 μm, preferably 4 to 100 μm. A thickness of 4 to 50 μm is preferred, especially 4 to 25 μm.

The number of layers for the housing shell can be adjusted depending on the thickness of the foil used. The thinner the foil, the more layers can be provided if necessary. The thickness of the foil used and the number of layers influence the strength and stability of the resulting housing shell. Furthermore, the size or form factor of the energy storage cell can also play a role in the choice of the thickness of the foil and the number of layers. The smaller the energy storage cell, the less material may be sufficient to achieve the required stability of the housing shell.

The design of the foil as a metal foil can be preferred for many reasons. For example, a housing shell formed of a metal foil is usually sufficiently resistant to common liquid electrolytes, has a high mechanical strength and can serve as a housing pole. In addition, a housing shell made of metal foil has the particular advantage that the metal material gives the housing shell particularly good heat-dissipating properties.

In some embodiments, however, the foil used to form the housing shell can also be a plastic foil. The plastic foil is preferably free of pores that can be penetrated by an electrolyte and preferably has electrically insulating properties. Fiber-reinforced plastic foils can be preferred. A housing shell formed of such a foil cannot serve as a housing pole. Pole bushings can be provided through the housing for contacting the electrodes, or the housing end faces can, for example, be metal and be in electrical contact with the electrodes. It is also possible to provide a pole bushing for contacting one of the electrodes and for contacting the other electrode to form one of the housing end faces of a metal and connect it electrically to the other electrode.

In other embodiments, it may be provided that the housing shell of the cell is formed of different foils, for example a multilayer metal foil wound on the winding-shaped electrode-separator assembly and a multilayer plastic foil wound on the metal foil layers, or vice versa.

### Advantages of the Invention

The concept with the formation of the housing shell by a wound foil, in particular a wound metal foil, offers various considerable advantages. In particular, the energy storage cell does not require a separate metal housing cup to form the housing, into which the electrode-separator assembly would have to be inserted in a separate work step and which would then have to be contacted, sealed and closed accordingly. Rather, the concept according to the invention makes it possible to carry out most of the assembly of the energy storage cell on a winding machine on which the electrode-separator assembly is already produced. With the concept, a separate assembly line for inserting the electrode-separator assembly and for assembling the housing can therefore be dispensed with.

Another particular advantage of the concept is that the interior space of the energy storage cell can be optimally utilized. The aforementioned free space between the outer diameter of the winding and the inner diameter of the cup is not required. The housing shell is wound directly onto the electrode-separator assembly, possibly only separated from it by a thin, electrically insulating layer. There is no free space between the winding and the housing shell to be formed. This means that the internal volume of the cell can be optimally utilized for the energy supply.

Avoiding a free space between the winding shell and the housing is also advantageous in terms of optimal cooling of the cell. In conventional cells, this free space, which is generally filled with air, can form a thermal insulation layer that makes it difficult to cool the cells.

A further particular advantage of the concept is that any uneven winding diameters that may occur as a result of the coating process during the manufacture of the electrode ribbons can be optimally compensated for. For example, if the coating with electrode material is already somewhat uneven, the diameter of the winding will be slightly larger or smaller for a given length of the wound electrode ribbons. Even small fluctuations in diameter can already lead to problems during assembly and to difficulties when inserting the electrode-separator assembly into the housing cup. This problem is also completely avoided with the concept.

Furthermore, the concept also results in considerable cost savings. Classic deep-drawn housing cups are significantly more expensive than the foil, in particular the metal foil, from which the housing shell is formed.

### Electrode-Separator Assembly

The electrode-separator assembly is first preferably produced in a manner known per se. Preferably, the electrode ribbons, i.e. in particular an electrode ribbon for the anode and an electrode ribbon for the cathode, as well as the at least one ribbon-shaped separator, are first provided for this purpose. Within the electrode-separator assembly, the arrangement of these ribbons is, for example, as follows: First electrode ribbon (e.g. anode)—ribbon-shaped separator second electrode ribbon (e.g. cathode)—ribbon-shaped separator. The ribbon-shaped anode, the ribbon-shaped cathode and the ribbon-shaped separator(s) are spirally wound in the ribbon-shaped electrode-separator assembly.

To produce the electrode-separator assembly, the ribbon-shaped electrodes together with the at least one ribbon-shaped separator are preferably fed to a winding device and wound up in this device, preferably in a spiral around a winding axis, for example a winding mandrel.

In some embodiments, the electrodes and the at least one separator are wound onto a cylindrical or hollow-cylindrical winding core for this purpose, which remains in the winding after winding. For this purpose, for example, a first ribbon-shaped separator can first be attached to the winding core, e.g. glued or welded on. The electrode ribbons and another ribbon-shaped separator between the electrode ribbons are inserted and the winding process is started.

Alternatively, the winding can also be formed on a winding mandrel, for example, which is pulled out of the winding again after the winding has been formed.

Within the electrode-separator assembly, the individual ribbons are not necessarily firmly bonded or laminated to each other, but they are in contact with each other, preferably in press contact.

It is also possible that a ribbon-shaped electrode-separator assembly is first formed of the ribbon-shaped electrodes, with the arrangement of a ribbon-shaped separator between the electrodes, and this electrode-separator assembly is then processed into the winding.

The winding shell can be formed by a plastic foil or an adhesive tape, for example. It is also possible for the winding shell to be formed by one or more turns of the ribbon-shaped separator.

In preferred embodiments, the electrode-separator assembly of the energy storage cell is characterized by at least one of the following features a. to c:
a. One of the electrode ribbons of the electrode-separator assembly is a positive polarity electrode ribbon comprising a ribbon-shaped cathode current collector having a first longitudinal edge and a second longitudinal edge parallel thereto and coated on both sides with a positive electrode material;
b. One of the electrode ribbons of the electrode-separator assembly is a negative polarity electrode ribbon comprising a ribbon-shaped cathode current collector having a first longitudinal edge and a second longitudinal edge parallel thereto and coated on both sides with a negative electrode material;
c. The at least one ribbon-shaped separator electrically insulates the oppositely polarized ribbon-shaped electrode bands from each other.

Preferably, the aforementioned features a. and b., and preferably the aforementioned features a., b. and c. are realized in combination.

### Preferred Electrochemical Embodiment

In preferred embodiments, the energy storage cell can be a lithium-ion cell, whereby in principle all electrode materials known for lithium-ion cells, in particular for all secondary lithium-ion cells, can be used for the electrodes or the electrode ribbons of the energy storage cell.

In particular, carbon-based particles, such as graphitic carbon or non-graphitic carbon materials capable of intercalating lithium, preferably also in particle form, can be used as active materials in the negative electrodes. Alternatively or additionally, lithium titanate (Li₄Ti₅O₁₂) or a derivative thereof can also be contained in the negative electrode, preferably also in particle form. Furthermore, the negative electrode can contain as active material at least one material from the group comprising silicon, aluminum, tin, antimony or a compound or alloy of these materials that can reversibly store and release lithium, for example silicon oxide (in particular SiOₓ with 0<x<2), optionally in combination with carbon-based active materials. Tin, aluminum, antimony and silicon can form intermetallic phases with lithium. The capacity for receptable lithium exceeds that of graphite or comparable materials many times over, especially in the case of silicon. Mixtures of silicon and carbon-based storage materials are suitable. Thin anodes made of metallic lithium are also suitable.

Suitable active materials for the positive electrodes include lithium metal oxide compounds and lithium metal phosphate compounds such as LiCoO₂ and LiFePO₄. Lithium nickel manganese cobalt oxide (NMC) with the chemical formula LiNiₓMn_{y}Co_{z}O₂ (where x+y+z is typically 1) is also suitable, lithium manganese spinel (LMO) with the chemical formula LiMn₂O₄, or lithium nickel cobalt aluminum oxide (NCA) with the chemical formula LiNiₓCo_{y}Al_{z}O₂ (where x+y+z is typically 1). Derivatives thereof, for example lithium nickel manganese cobalt aluminum oxide (NMCA) with the chemical formula Li_{1.11}(Ni_{0.40}Mn_{0.39}Co_{0.16}Al_{0.05})_{0.89}O₂ or Li₁₊ₓM—O compounds and/or mixtures of the aforementioned materials can also be used. The cathodic active materials are also preferably used in particulate form.

In addition, the electrodes of an energy storage cell preferably contain an electrode binder and/or an additive to improve the electrical conductivity. The active materials are preferably embedded in a matrix of the electrode binder, with neighboring particles in the matrix preferably being in direct contact with each other. Conductive agents have the function of elevating the electrical conductivity of the electrodes. Suitable electrode binders are based, for example, on polyvinylidene fluoride (PVDF), lithium polyacrylate, styrene-butadiene rubber or carboxymethyl cellulose or mixtures of different binders. Suitable conductive agents are carbon black, fine graphite, carbon fibers, carbon nanotubes and metal powder.

The energy storage cell comprises preferably an electrolyte, in the case of a lithium-ion cell in particular an electrolyte based on at least one lithium salt such as lithium hexafluorophosphate (LiPF₆), which is present dissolved in an organic solvent (e.g. in a mixture of organic carbonates or a cyclic ether such as THF or a nitrile). Other lithium salts that can be used are, for example, lithium tetrafluoroborate (LiBF₄), lithium bis(trifluoromethanesulfonyl)imide (LiTFSI), lithium bis(fluorosulfonyl)imide (LiFSI) and lithium bis(oxalato)borate (LiBOB).

Preferably, the layers of positive and negative electrode material and the at least one ribbon-shaped separator are impregnated with the electrolyte.

The at least one separator is preferably formed of an electrically insulating plastic foil. It preferably has pores so that it can be penetrated by the liquid electrolyte. The plastic foil can consist of a polyolefin or a polyether ketone, for example. Nonwovens and fabrics made of plastic materials or other electrically insulating fabrics can also be used as separators. Separators with a thickness in a range from 5 μm to 50 μm are preferred.

However, it is also possible that the ribbon-shaped separator is a separator made of a solid-state electrolyte that has an intrinsic ionic conductivity and does not need to be impregnated with a liquid electrolyte. The solid-state electrolyte can, for example, be a polymer solid-state electrolyte based on a polymer-conducting salt complex, which is present in a single phase without any liquid component. The polymer matrix of a solid-state polymer electrolyte can be polyacrylic acid (PAA), polyethylene glycol (PEG) or polymethyl methacrylate (PMMA). Lithium conductive salts such as lithium bis-(trifluoromethane)sulfonylimide (LiTFSI), lithium hexafluorophosphate (LiPF₆) and lithium tetrafluoroborate (LiBF₄) can be present in these.

### Nominal Capacity

The nominal capacity of a lithium-ion-based energy storage cell designed as a cylindrical round cell is preferably up to 15000 mAh. With a form factor of 21×70, the energy storage cell in an embodiment as a lithium-ion cell preferably has a nominal capacity in a range from 1500 mAh to 7000 mAh, preferably in a range from 3000 to 5500 mAh. With a form factor of 18×65, the cell in an embodiment as a lithium-ion cell preferably has a nominal capacity in a range from 1000 mAh to 5000 mAh, preferably in a range from 2000 to 4000 mAh.

In the European Union, manufacturers' specifications regarding the nominal capacities of secondary energy storage cells are strictly regulated. For example, information on the nominal capacity of secondary nickel-cadmium cells must be based on measurements in accordance with the IEC/EN 61951-1 and IEC/EN 60622 standards, information on the nominal capacity of secondary nickel-metal hydride cells must be based on measurements in accordance with the IEC/EN 61951-2 standard, information on the nominal capacity of secondary lithium cells must be based on measurements in accordance with the IEC/EN 61960 standard and information on the nominal capacity of secondary lead-acid cells must be based on measurements in accordance with the IEC/EN 61056-1 standard. Any information on nominal capacities in the present application is preferably also based on these standards.

### Preferred Embodiments of Current Collectors/Separators

The anode current collector ribbon, the cathode current collector ribbon and the at least one ribbon-shaped separator of the cell preferably have the following dimensions:
A length in a range from 0.5 m to 25 m;
a width in a range from 40 mm to 145 mm.

The current collectors of the energy storage cell have the function of electrically contacting electrochemically active components contained in the respective electrode material over as large an area as possible. In particular, the ribbon-shaped metal foils consist of a metal foil or are at least metallized on the surface.

In the case of a lithium-ion cell, suitable metals for the anode current collector are, for example, copper or nickel or other electrically conductive materials, in particular copper and nickel alloys or metals coated with nickel. In particular, materials of type EN CW-004A or EN CW-008A with a copper content of at least 99.9% can be used as copper alloys. Alloys of the type NiFe, NiCu, CuNi, NiCr and NiCrFe are suitable as nickel alloys. Stainless steel can also be considered, for example type 1.4303 or 1.4404 or type SUS304.

In the case of a lithium-ion cell designed as an energy storage cell, aluminum or other electrically conductive materials, including aluminum alloys, are suitable as a metal for the cathode current collector.

Suitable aluminum alloys for the cathode current collector are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

Preferably, the anode current collector and/or the cathode current collector are each a ribbon-shaped metal foil with a thickness in a range from 4 μm to 30 μm.

With regard to the formation of the housing shell of the energy storage cell by means of a spirally wound foil, two variants are preferred. In the first of these variants, the housing shell is formed by a terminal section of one of the current collectors, which is contained in the electrode-separator assembly. In the second variant, the housing shell is formed by a separate metal foil.

### Formation of the Housing Shell From the Terminal Current Collector Section

According to the first variant, the energy storage cell is characterized by at least one of the following additional features a. to c:
a. The spirally wound foil that forms the housing shell of the energy storage cell is a spirally wound terminal section of the ribbon-shaped cathode current collector that is not coated with the positive electrode material;
b. The spirally wound foil that forms the housing shell of the energy storage cell is a spirally wound terminal section of the ribbon-shaped anode current collector that is not coated with the negative electrode material;
c. The ribbon-shaped cathode current collector and the ribbon-shaped anode current collector have an essentially constant width over their entire length.

The aforementioned features a. and b. are to be regarded as alternatives, so that in this variant the housing shell is either formed by the metal foil which also forms the cathode current collector of the electrode-separator assembly or by the metal foil which also forms the anode current collector of the electrode-separator assembly.

In a preferred manner, the aforementioned features a. and c., or b. and c. are realized in combination with each other.

In the case where the housing shell is formed by the uncoated cathode current collector ribbon, the structure of the electrode-separator assembly is preferably as follows: Viewed from the inside to the outside, the negative electrode ribbon including the anode current collector ribbon ends first. The coating on both sides of the cathode current collector also ends in this region. However, the metal foil ribbon that forms the cathode current collector continues. The ribbon-shaped separator or separators also continue for two or three turns, for example. Then the ribbon-shaped separator or separators also end, leaving only the uncoated cathode current collector ribbon. The cathode current collector ribbon is then wound up in several turns to form the housing shell.

In the case where the housing shell is formed by the uncoated anode current collector ribbon, the structure of the electrode-separator assembly is preferably as follows: Viewed from the inside to the outside, the positive electrode ribbon including the cathode current collector ribbon ends first. The coating of the anode current collector also ends in this region, but it continues with the ribbon-shaped separator(s) for two or three turns, for example. The ribbon-shaped separators then also end, leaving the uncoated anode current collector, which is wound in several turns to form the housing shell.

### Formation of the Housing Shell From Separate Metal Foil

In the second preferred variant of the energy storage cell, the housing shell is formed by the separate metal foil (shell metal foil). In this case, the energy storage cell is characterized by at least one of the following additional features a. to d:
a. The spiral-wound foil that forms the housing shell of the energy storage cell is a spiral-wound metal foil ribbon that is wound onto the winding shell of the electrode-separator assembly;
b. The winding shell of the electrode-separator assembly is made of an electrically insulating material;
c. The metal foil ribbon has an essentially constant width over its entire length;
d. The metal foil ribbon has a greater width than the ribbon-shaped cathode current collector and/or the ribbon-shaped anode current collector of the electrode-separator assembly.

In preferred embodiments, the aforementioned features a. and b., or a. to c., or a. to d. are realized in combination with one another.

The electrically insulating material according to the aforementioned feature b. may in particular be turns of the at least one ribbon-shaped separator. Alternatively or additionally, a separate adhesive film or the like can be applied to the electrode-separator assembly to form the winding shell after completion of the winding of the electrode-separator assembly or after the end of the electrode ribbons and, if applicable, of the at least one ribbon-shaped separator.

It can be advantageous if the metal foil ribbon for the housing shell has a greater width than the ribbon-shaped current collectors of the electrode-separator assembly in order to simplify the formation of a subsequent connection between the housing shell and the housing end faces, for example by welding.

However, it is also possible that the same metal ribbon used as the anode current collector or the cathode current collector is used as the metal foil ribbon. It is thus possible, after winding the electrode ribbons, to cut the electrode ribbons, form the winding shell by continuing to wind the at least one ribbon-shaped separator, then insert the same metal ribbon that is used as the anode current collector or as the cathode current collector in the anode or the cathode between two turns of the separator and then cut the separator so that only the metal ribbon is wound further.

### Choice of Material for Housing Shell

In preferred embodiments of the energy storage cell, the energy storage cell is characterized by one of the following features a. to c. with regard to the material of the foil for the housing shell:
a. The spirally wound metal foil that forms the housing shell of the energy storage cell consists of aluminum or an aluminum alloy;
b. The spirally wound metal foil that forms the housing shell of the energy storage cell consists of copper or nickel or a copper alloy or a nickel alloy.
c. The spirally wound foil that forms the housing shell of the energy storage cell consists of plastic.

The aforementioned features a. and b. and c. are generally to be understood as alternatives. In principle, however, it is also possible for the housing shell to be formed by several metal foils of different materials or by a metal foil and a plastic foil.

The metal foil of aluminum or of an aluminum alloy according to the immediately above-mentioned feature a. may preferably be a terminal section of the cathode current collector (according to the above first preferred variant). The metal foil of copper or nickel or of a copper alloy or of a nickel alloy according to the aforementioned feature b. may preferably be a terminal section of the anode current collector (according to the above first preferred variant). In other embodiments, these metal foils (according to the above second preferred variant) may be separate metal foils which are separate from the current collector ribbons and may have a different width.

The use of aluminum or an aluminum alloy as the metal foil for forming the housing shell may be preferred, as it is the more cost-effective material compared to copper or nickel.

However, the use of copper or nickel or a copper alloy or nickel alloy for the metal foil that forms the housing shell can offer particular advantages, as these materials can generally be welded very well.

As stated above, in some embodiments, the at least one foil may also be a plastic foil. One suitable material for the foil would be a polyether ketone.

In some preferred embodiments, it is also possible to cover the spirally wound metal foil forming the housing shell with a plastic cover for mechanical stabilization and/or to seal the housing. This plastic cover can, for example, be formed of a molded plastic part or two or more preformed molded plastic parts that are joined together by welding or bonding. Another option is to cover the shell and, if necessary, at least parts of the housing end faces with a liquid plastic or a liquid plastic precursor, for example by overmoulding in a suitable injection mould.

### Adhesive Layer

In preferred embodiments, the energy storage cell is characterized by the following additional feature:
a. The layers formed of the at least one foil, in particular the metal foil, which form the housing shell of the energy storage cell, are connected to each other by an adhesive layer arranged between the layers of the foil, in particular the metal foil.

Bonding the layers of the housing shell can be advantageous, as this can improve the tightness of the housing. Standard liquid adhesives or hot-melt adhesives or similar can be used for this purpose. For example, thermoplastics can be used, which are then thermally cured. Suitable plastics can also be sealed in, for example on the basis of polyurethane or similar.

Adhesive tapes whose both sides can form an adhesive bond to the layers of the foil, in particular the metal foil, can also be used as an adhesive layer. Adhesive tapes coated on both sides with an adhesive or tapes that have intrinsic adhesive properties are suitable for this purpose.

In preferred embodiments, such an adhesive layer can be sprayed or squeegeed onto the at least one foil before it is wound. For example, the last few centimeters of a current collector that is uncoated in this section and is intended to form the housing shell can be pre-coated with a thermoplastic.

### Design of the Housing End Faces

In a preferred embodiment of the energy storage cell, the cell is characterized by at least one of the following additional features a. to d:
a. The first housing end face of the energy storage cell is formed by a round, in particular circular, metal disc or a metal cap comprising a round, in particular circular, bottom and a circumferential side wall;
b. The metal disc or cap forming the first housing end face is connected to the housing shell by welding;
c. The second end face of the housing of the energy storage cell is formed by a round, in particular circular, metal disc or a metal cap comprising a round, in particular circular, bottom and a circumferential side wall;
d. The metal disc or cap forming the second end face of the housing is connected to the housing shell by welding.

In preferred embodiments, the aforementioned features a. and b., or the aforementioned features c. and d. are realized in combination with each other. In principle, both end faces of the housing can also be formed by a round metal disc or a metal cap, so that the aforementioned features a. and c. or, preferably, the aforementioned features a. to d. are realized in combination with each other.

The circumferential side wall of the cap is preferably an inwardly projecting collar of the cap. Preferably, the side wall is at an angle of approximately 90° to the circular bottom. This circumferential side wall can facilitate the assembly and joining of the individual elements of the energy storage cell and the connection of the housing shell to the end faces of the housing.

The round shape of the metal disc or the round shape of the bottom of the cap is characterized in that the shape has no corners and can therefore be easily integrated into the winding process. A circular shape is preferred, which is thus well adapted to a uniformly wound electrode-separator assembly with a circular base.

### Pole Bushing Through the End Face of the Housing

In a further preferred embodiment of the energy storage cell, the cell is characterized by at least one of the following additional features a. and b:
a. An electrical contact pole is led through the first and/or second housing end face, which is electrically insulated from the respective housing end face and which is electrically connected to one of the ribbon-shaped current collectors directly or via a metal conductor;
b. One of the ribbon-shaped current collectors is electrically connected directly or via a metal conductor to the metal disc or cap forming the first end face of the housing or to the metal disc or cap forming the second end face of the housing.

In some preferred embodiments, the aforementioned features a. and b. are realized in combination with one another, wherein one of the poles of the energy storage cell, for example the negative pole, is formed by a contact pole projecting from one end face of the housing and the other pole of the energy storage cell, for example the positive pole, is formed by the opposite end face of the housing.

The contact pole, which is guided through one of the end faces, can be a hollow bolt, for example, through the cavity of which welding can be carried out so that the bolt can be attached to an underlying component. The opening of the bolt can then be closed. The bolt itself is conveniently electrically insulated from the rest of the housing end face, for example by a plastic, ceramic or glass seal. For the assembly of the energy storage cell, it is advantageous if a cap or disc forming the respective end face of the energy storage cell forms a pre-assembled closure component with the insulated bolt, which can be assembled as such.

### Direct Connection of a Current Collector to the End Face of the Housing

In preferred embodiments of the energy storage cell, the cell is characterized by at least one of the following additional features a. to c:
a. The ribbon-shaped anode current collector comprises a main region loaded with a layer of the negative electrode material and a free edge strip extending along its first longitudinal edge, which is not loaded with the negative electrode material;
b. The ribbon-shaped cathode current collector comprises a main region loaded with a layer of positive electrode material and a free edge strip extending along its first longitudinal edge which is not loaded with the positive electrode material;
c. The electrode ribbons are arranged within the electrode-separator assembly, which is designed as a winding, in such a way that
the first longitudinal edge of the anode current collector or the first longitudinal edge of the cathode current collector protrudes from one of the terminal winding end faces,
or that
the first longitudinal edge of the cathode current collector protrudes from one terminal winding end face and the first longitudinal edge of the anode current collector protrudes from the other terminal winding end face of the electrode-separator assembly.

Preferably, the aforementioned features a. and c., or b. and c., or, preferably, a., b. and c. are realized in combination with one another.

In the embodiment mentioned above, in which the ribbon-shaped current collectors are directly connected to the metal disc or cap forming the first housing end face or to the metal disc or cap forming the second housing end face, the first longitudinal edge of the anode current collector protruding from one of the terminal winding end faces or the first longitudinal edge of the cathode current collector is preferably directly connected to the metal disc or cap, preferably by a weld.

The edge strips of the current collectors, which protrude from the respective winding end faces and which are free of electrode material, allow advantageous contacting of the electrodes in accordance with the following, preferred feature:
a. One of the ribbon-shaped current collectors is directly connected to the metal disc or metal cap forming the first end face of the housing or to the metal disc or metal cap forming the second end face of the housing, wherein the first longitudinal edge or the free edge strip of the respective current collector rests directly on the metal disc or the bottom of the cap and is connected to the disc or the bottom of the cap by a weld, preferably over its entire length.

This form of direct contacting of the current collectors via their longitudinal edges allows the electrodes to be contacted over their entire length. Cells with such contacting of the electrodes are characterized by a significantly reduced internal resistance, so that large currents can be intercepted much better than with conventional contacting of the electrodes and heat can also be dissipated better from the winding.

In some preferred embodiments, this type of contacting is provided either only for the anode or only for the cathode, preferably only for the cathode, whereby for the other electrode, in particular for the anode, contacting can be provided, for example, via a contact strip or the like, as will be described below.

### Electrical Connection of a Current Collector Via at Least One Contact Strip

In further preferred embodiments of the energy storage cell, at least one of the following additional features a. and b. is provided:
a. At least one of the ribbon-shaped current collectors has at least one free section which is not coated with the electrode material and to which a metal contact strip is welded;
b. The metal contact strip welded to the current collector protrudes from one of the winding end faces.

Preferably, the aforementioned features a. and b. are realized in combination with each other.

The metal contact strip, which can also be referred to as the arrester strip, allows the electrodes to be contacted easily. Preferably, the metal contact strip is perpendicular to the winding or running direction of the electrode ribbon or the ribbon-shaped current collector.

The contacting of one of the electrode ribbons via such a contact strip can be combined with other contacting options. It may be provided that one of the electrodes is contacted via a contact strip and the other electrode is contacted in another way, for example via a direct connection of a longitudinal edge of one of the spirally wound electrode ribbons to an end-face, plate-shaped metal sheet.

The contact strips are preferably made of the same materials as the respective current collector. For example, a contact strip made of copper or a copper alloy is suitable as a contact strip for the anode and a contact strip made of aluminum or an aluminum alloy is suitable as a contact strip for the cathode.

In a preferred further development of this aspect of the invention, the energy storage cell is characterized by the following additional feature a:
a. The metal contact strip welded to the current collector is connected directly to the metal disc or cap forming the first end face of the housing or to the metal disc or cap forming the second end face of the housing, preferably by a weld.

Preferably, only one of the current collectors is connected to the first or second housing end face in this way via a metal contact strip. The current collector of the electrode with the opposite polarity is preferably contacted in a different way.

In the embodiment mentioned above, in which the ribbon-shaped current collectors are connected via an electrical conductor to the metal disc or cap forming the first end face of the housing or to the metal disc or cap forming the second end face of the housing, the electrical conductor is preferably the contact strip. The contact strip can be welded directly to the metal disc or cap.

The winding end face, from which the contact strip or one of the longitudinal edges of the current collectors protrudes, is formed by at least one longitudinal edge of the at least one ribbon-shaped separator, which protrude slightly beyond the coating of the electrode ribbons on the end face of the winding.

### Targeted Deformation of the Longitudinal Edge of the Current Collectors

In preferred embodiments, the energy storage cell is characterized by at least one of the following additional features a. and b:
a. The first longitudinal edge of the anode current collector and/or the first longitudinal edge of the cathode current collector protrudes from one of the terminal winding end faces and has a spiral shape;
b. At least the outer turn of the first longitudinal edge is bent in the direction of a central axis of the electrode-separator assembly or in the direction away from the central axis.

Preferably, the aforementioned features a. and b. are realized in combination with each other.

Bending the first longitudinal edge of the current collectors protruding from one or both winding end faces is advantageous when assembling the energy storage cell, as in this way a cap or a disk on the end face can be attached well and efficiently to the respective winding end face.

### Metal Contact Element

In preferred embodiments of the energy storage cell, the cell is characterized by at least one of the following additional features a. to e:
a. The energy storage cell comprises at least one metal contact element, optionally including a separate electrical conductor fixed to the contact element, which is connected to the first longitudinal edge of the cathode current collector or the anode current collector by welding, in some preferred embodiments over its entire length, and via which this current collector is electrically connected to the metal disc or cap forming the first housing end face or to the metal disc or cap forming the second housing end face;
b. The contact element sits flat on the first longitudinal edge of the cathode current collector or the anode current collector;
c. The contact element comprises a first element which sits flat on the first longitudinal edge of the current collector protruding from the first or the second terminal end face and extends parallel to the respective winding end face, and comprises a second element which adjoins the first element at an angle and via which the first element is electrically connected to the metal disc or cap forming the first housing end face or to the metal disc or cap forming the second housing end face;
d. The contact element is connected directly to the metal disc or cap forming the first housing end face or to the metal disc or cap forming the second housing end face, in particular by welding;
e. The contact element is in contact directly or via an electrical conductor with an electrical contact pole routed through the first and/or second housing end face.

In preferred embodiments, the aforementioned features a. and b., or a. and b. and c., or a. and b. and c. and d., or features a. to e. are realized in combination with one another.

In particular, it is preferred if such a contact element sits on the first longitudinal edge of the anode current collector.

The contact element is preferably a sheet metal component, for example in the form of a cap or disk or in the form of a strip. The sheet metal component preferably has a thickness in a range from 0.05 to 1.0 mm.

The contact element can also be a star-shaped sheet metal component.

Preferably, the energy storage cell comprises an insulating element which electrically insulates the contact element from a metal disc or cap forming the end face of the housing by preventing direct contact between the contact element and the metal disc or cap. In this embodiment, a contact pole according to the aforementioned feature e. is preferred, whereby the electrical contact is routed to the outside. The contact pole, for example a conventional contact bolt, makes contact with the contact element, which in turn is in electrical contact with the respective electrode.

This realization of electrical contacting with a contact pole can be provided in particular for the anodic side, whereas the aforementioned feature d. can be provided, for example, for the cathodic side of the energy storage cell.

Alternatively, in a preferred embodiment, a contact element can be dispensed with on the cathode side, for example, so that the housing end face on the cathode side is formed by a metal disc or a metal cap, for example, which is in direct contact with the free edge strip of the cathode current collector emerging from this side of the winding. Alternatively, an electrical connection can also be made via a metal contact strip as described above.

There are two preferred variants (variant A and variant B) for electrically assembling the contact element, which is preferably connected by welding to the first longitudinal edge or the free edge strip of the current collector protruding from the first terminal winding end face, to the metal disc or metal cap forming the housing end face, each of which is also to be referred to as a cover component.

According to variant A, the cell is characterized by at least one of the features a. to c. immediately below:
a. The contact element is directly connected to the cover component.
b. The contact element comprises a first element or a first section which sits flat on the first longitudinal edge of the current collector protruding from the terminal winding end face and extends parallel to the winding end face.
c. The contact element comprises a second element or a second section, which is angled to the first section and via which the first section is electrically connected to the cover component.

It is preferred that the immediately preceding features a. and b. are realized in combination. It is preferred that the immediately preceding features a. to c. are realized in combination.

According to variant B, the cell is characterized by at least one of the features a. and b. immediately below:
a. The contact element is connected to the cover component via the separate electrical conductor.
b. The contact element sits flat on the first longitudinal edge of the current collector protruding from the terminal winding end.

It is preferred that the immediately preceding features a. and b. are realized in combination.

If the separate electrical conductor is used, it preferably consists of the same material as the contact element itself.

Of course, it is not only the first longitudinal edge of the current collector protruding from one terminal winding end that needs to be electrically contacted. Rather, the first longitudinal edge of the current collector protruding from the other terminal winding end face must also be electrically contacted. The following two variants C and D are preferred:

According to variant C, the cell is characterized by the feature a. immediately below:
a. The first longitudinal edge of the current collector protruding from the other terminal winding end face sits directly on a metal disc or cap forming this housing end face and is connected to it by welding.

According to variant D, the cell is characterized by feature b. immediately below:
b. The energy storage cell comprises a contact element which is connected by welding to the first longitudinal edge of the current collector protruding from the other terminal winding end face and via which this current collector is electrically connected to a metal disc or metal cap forming this housing end face.

In both cases, the longitudinal edge of the current collector protruding from the other terminal winding end can be electrically and/or thermally connected over its entire length, as in the case of the current collector protruding from the opposite terminal winding end.

The energy storage cell is preferably characterized by the following feature a:
a. The current collector protruding from the first terminal winding end face is the anode current collector and the current collector protruding from the second winding end face is the cathode current collector.

This configuration is advantageous if the foil forming the housing shell consists of aluminum or an aluminum-containing alloy, as the cathode current collector is also preferably made of aluminum.

In a preferred further development of the invention, the contact element electrically connected to the anode current collector is characterized by at least one of the features a. and b. immediately below:
a. The contact element consists of nickel or copper or titanium or a nickel or copper or titanium alloy or stainless steel, for example of type 1.4303 or 1.4404 or of type SUS304, or of nickel-plated copper.
b. The contact element consists of the same material as the anode current collector.

It is preferred that the immediately preceding features a. and b. are realized in combination.

Copper is a preferred material for the contact element that is connected to the anode current collector.

In embodiments in which the cathode current collector is also electrically connected via a contact element, this contact element is characterized by at least one of the features a. and b. immediately below:
a. The contact element consists of aluminum or an aluminum alloy.
b. The contact element consists of the same material as the cathode current collector.

It is preferred that the immediately preceding features a. and b. are realized in combination.

Aluminum is a preferred material for the contact element that is connected to the cathode current collector.

Contact elements that can be used for contacting the longitudinal edges of the current collectors are preferably characterized by at least one of the immediately following features a. to g:
a. They have a preferably uniform thickness in a range from 50 μm to 600 μm, preferably in a range from 150 μm to 350 μm.
b. They have two opposite flat sides and essentially extend in only one dimension.
c. They are designed as a disk or as a polygonal plate or star-shaped or comprise such a disk or plate.
d. They are dimensioned in such a way that they cover at least 40%, preferably at least 60%, preferably at least 70% of the first terminal and/or the second terminal winding end face.
e. They have at least one aperture, in particular at least one hole and or at least one slot.
f. They have at least one bead which is formed as an elongated depression on one flat side of the contact element and as an elongated elevation on the opposite flat side, with the flat side bearing the elongated elevation resting on the first longitudinal edge of the respective current collector.
g. They are welded to the first longitudinal edge of the respective current collector in the region of the bead, in particular via one or more weld seams arranged in the bead.

It is preferred that the immediately preceding features a. and b. and d. are realized in combination with each other. In a preferred embodiment, features a. and b. and d. are realized in combination with one of features c. or e. or features f. and g.. Preferably, all features a. to g. are realized in combination with each other.

Covering the winding end face as extensively as possible is important for the thermal management of the energy storage cell. The larger the cover, the easier it is to contact the first longitudinal edge of the respective current collector over its entire length if possible. The heat formed in the electrode-separator assembly can thus be dissipated well via the contact element(s).

### Current Collector Pre-Treatment

In some embodiments, it has proven advantageous to subject the longitudinal edge of a current collector to a pre-treatment before a contact element is placed on it. In particular, at least one depression can be folded into the longitudinal edge, which corresponds to the at least one bead or the elongated elevation on the corresponding flat side of the contact element. This also applies with regard to the attachment of a metal disc or cap, which forms a housing end face and which may be in direct contact with the respective winding end face. This metal disc or cap can also be provided with one or more beads, which can facilitate contact with the edges of the current collector.

The longitudinal edges of the current collectors may also have been subjected to directional forming by pre-treatment. For example, they can be bent in a defined direction, in particular in the direction of a central axis of the electrode-separator assembly, as already described above in connection with the contacting of the metal disc or cap.

The at least one aperture in the contact elements can be used with particular advantage to impregnate the electrode-separator assembly with an electrolyte during assembly of the energy storage cell. This aperture can then be closed with a blind rivet, for example.

### Preferred Feature Combinations

In a preferred embodiment of the energy storage cell, the cell is characterized by at least one of the following features a. to f., preferably by a combination of the following features a. to f.:
a. The spirally wound foil forming the housing shell of the energy storage cell is a spirally wound terminal section of the ribbon-shaped cathode current collector that is not coated with the positive electrode material, or a spirally wound terminal section of the ribbon-shaped cathode current collector that is not coated with the positive electrode material;
b. The first housing end face of the energy storage cell is formed by a metal cap comprising a round, in particular circular, bottom and a circumferential side wall, the cap having an opening edge which delimits the circumferential side wall;
c. The opening edge of the cap forming the first housing end face is connected to the housing shell by welding;
d. The second housing end face of the energy storage cell is formed by a metal cap comprising a round, in particular circular, bottom and a circumferential side wall;
e. The spirally wound foil lies against the side wall of the cap forming the second end face of the housing from the outside;
f. The spirally wound foil is connected to the side wall of the cap forming the second end face of the housing by a circumferential weld seam.

This embodiment of the energy storage cell in accordance with the aforementioned features a. to f. is thus characterized in particular by the fact that the housing shell is formed by a terminal section of one of the current collectors, which is wound around the electrode-separator assembly. Preferably, this is the cathode current collector, which is formed of aluminum or an aluminum alloy.

It is preferable for the first end face of the housing to form the negative pole of the cell, i.e. the anodic side, and the second end face of the housing to form the positive pole, i.e. the cathodic side of the cell.

With particular advantage, it can be provided that, in addition to the aforementioned features a. to f., the first end face of the housing also comprises a contact element. This contact element is preferably in direct electrical contact with the free edge regions of the anode current collector protruding on this side of the winding. Preferably, the contact element is also electrically insulated from the cap forming this first end face of the housing. In addition, a pole bushing is preferably provided on this end face of the housing, which leads the electrical contact, i.e. the negative pole, to the outside on this end face of the cell.

In another preferred embodiment of the energy storage cell, the cell is characterized by at least one of the following features a. to f., wherein a combination of these following features a. to f. is preferably provided:
a. The spirally wound foil, which forms the housing shell of the energy storage cell, is a spirally wound foil ribbon, in particular a metal foil ribbon, which is wound onto the winding shell of the electrode-separator assembly;
b. The first housing end face of the energy storage cell is formed by a metal disk, the disk having a boundary edge;
c. The boundary edge of the disk forming the first housing end face is connected to the housing shell by welding;
d. The second housing end face of the energy storage cell is formed by a metal cap comprising a round, in particular circular, bottom and a circumferential side wall;
e. The spirally wound foil lies against the side wall of the cap forming the second end face of the housing from the outside;
f. The spirally wound foil is connected to the side wall of the cap forming the second end face of the housing by a circumferential weld seam.

In contrast to the previous embodiment, an energy storage cell according to this preferred embodiment is characterized by the fact that not one of the current collectors forms the housing shell, but that a separate foil ribbon, in particular a metal foil ribbon, is provided for this purpose, which is wound onto the winding shell of the electrode-separator assembly. This foil ribbon can have a slightly greater width than the electrode ribbons and the ribbon-shaped electrode-separator assembly, so that the wound housing shell has a greater height than the winding. The housing end faces can be designed accordingly, in that a metal disk is provided instead of a metal cap, particularly in the region of the first housing end face. This is an advantageous way of achieving a flush finish on the first end face of the housing. Moreover, this embodiment of the energy storage cell can be designed in a similar way to the embodiment of the energy storage cell described above.

It may also be preferable for the foil ribbon, in particular the metal foil ribbon, to be thicker than the current collectors of the electrode ribbons. Fewer turns are then required to form the housing shell.

In preferred embodiments of the energy storage cell, an insulating element is expediently provided at least in a range from one of the end faces of the cell. In particular, the insulating element can electrically insulate the metal disc or the cap forming the first end face of the housing from a contact element provided in this region and the upper region of the winding in this region of the cell.

### Insulating Element

The insulating element can be realized as follows, wherein in a first embodiment the energy storage cell is characterized by at least one of the following features a. to c:
a. The at least one insulating element is or comprises an insulating tape which is applied to the edge delimiting the winding end face and protects it from direct contact with the inside of the housing end face and/or the housing shell.
b. The at least one insulating element is or comprises an annular molded part made of plastic, preferably with an L-shaped cross-section, which is applied to the edge delimiting the winding end face and protects it from direct contact with the inside of the housing end face and/or the housing shell.
c. The insulating tape or the annular molded plastic part has a thickness in a range from 10 μm to 200 μm.

It is preferred that the immediately preceding features a. and c., or b. and c. are realized in combination with each other.

The insulating tape can be a Kapton/polyimide adhesive tape, for example.

The annular molded plastic part, preferably with an L-shaped cross-section, can be injection molded, for example, and pushed onto the edge to be protected. It can consist of Teflon or polyamide, for example.

In a further preferred embodiment of this aspect of the invention, the energy storage cell is characterized by at least one of the features a. and b. immediately below:
a. The at least one insulating element is or comprises an electrically insulating plastic coating which encloses an edge of the contact element.
b. The electrically insulating coating is formed by overmolding the edge of the contact element.

It is preferred that the immediately preceding features a. and b. are realized in combination.

Basically, all thermoplastics with electrically insulating properties are suitable for overmolding the edge of the contact element. Polyamide, for example, is suitable.

If necessary, a combination of these embodiments of the insulating element can also be provided, whereby an insulating tape or annular molded part made of plastic is implemented in addition to a plastic coating of the edge of the contact element.

In preferred embodiments, the energy storage cell is characterized by at least one of the following additional features:
a. The metal cap, which forms at least one of the end faces of the housing, has a circumferential depression, in particular an annular depression, in its edge region, which is bounded on the outside by the circumferential side wall of the metal cap;
b. The circumferential side wall of the metal cap lies flat against the foil that forms the housing shell.

Preferably, the aforementioned features a. and b. are realized in combination with each other.

The particular advantage of this embodiment lies above all in the fact that the circumferential depression in the metal cap provides a good engagement option for welding the foil forming the housing shell to the end face of the housing, i.e. to the metal cap. This depression makes it possible, for example, to apply a laser beam in a suitable way so that it first penetrates the (generally thicker) side wall of the metal cap to weld the housing shell to the cap before it hits the foil layers of the housing shell. It has been found that this creates a stable connection between the housing shell and the end face of the housing. In particular, the laser beam can be applied in such a way that it penetrates all foil layers of the housing shell from the inside to the outside.

In particular, the depression itself can be designed as an annular gap or groove and can be produced in a deep-drawing process, for example. Preferably, it has a triangular cross-section.

### Method

The invention further comprises a method of manufacturing an energy storage cell having a cylindrical, liquid-tight sealed housing with a first housing end face and a second housing end face and a housing shell as described above. In this method, the following steps are comprised:
a. An electrode-separator assembly in the form of a winding with two terminal winding end faces and a winding shell is produced on a winding machine, the electrode-separator assembly being formed, in particular wound, from electrode ribbons between which at least one ribbon-shaped electrode-separator is arranged, the electrode ribbons preferably each comprising a ribbon-shaped electrode which is coated with electrode material;
b. The housing shell is formed by winding a foil, in particular a metal foil.

The housing shell of the energy storage cell is preferably formed by winding the foil, in particular the metal foil, spirally around the electrode-separator assembly, in particular in such a way that it comprises at least two layers of the foil, in particular the metal foil.

The current collectors are preferably coated with electrode material on both sides.

The electrode-separator assembly is preferably manufactured in the conventional manner on a winding machine. The decisive difference to conventional manufacturing processes for energy storage cells with a wound electrode-separator assembly lies in the formation of the housing shell. According to the present disclosure, the housing shell is formed by winding at least two layers of the foil, in particular the metal foil, on the winding shell of the electrode-separator assembly. The advantages associated with this, firstly with regard to the optimum utilization of the internal volume of the energy storage cell and secondly, above all, in the significantly simplified manufacturing process, have already been explained in connection with the energy storage cell itself. In particular, this method allows a significant simplification of the system technology and the associated cost savings, as the housing shell can be produced on the winding machine by continuing the winding process. A separate assembly line for inserting the winding into a housing and for assembling the housing can be dispensed with.

In the method, two variants are preferred. In the first variant, the method is characterized by the following additional feature a. immediately below:
a. To form the housing shell of the energy storage cell, the housing shell is formed of a terminal section of one of the current collectors after the electrode-separator assembly has been manufactured.

This terminal section of the ribbon-shaped current collector is not coated with electrode material.

In the second variant, the method is characterized by the following additional feature b. immediately below:
b. To form the housing shell of the energy storage cell, a separate foil, in particular a separate metal foil, is wound onto the winding shell of the electrode-separator assembly after the electrode-separator assembly has been manufactured.

Reference is made to the above description of preferred embodiments of the energy storage cell with regard to further details of the method and the energy storage cell that can be produced using this method.

In preferred embodiments, the method comprises the following additional feature:
a. After winding at least two layers of the foil, in particular the metal foil, to form the housing shell on the winding shell of the electrode-separator assembly, the housing shell formed is welded, in particular laser-welded, to the edge regions of the housing end faces.

By welding the housing shell formed by the metal foil layers to the edge regions of the housing end faces, the liquid-tight sealed housing can be formed in an advantageous way. Such welds are widely used in a range from the assembly of energy storage cells and can be carried out very accurately and precisely and also in an automated manner.

Depending on the specific realization of the housing end faces, which, as described above, can be realized in particular as a metal disc or cap or in the form of a combination of cap with contact element or disc with contact element, the welding can start in different regions. For example, it is possible for the metal foil layers that form the housing shell to be wound from the outside over a circumferential side wall of a metal cap that forms the end face of the housing. In this case, the housing shell can be attached and sealed to the cap by laser welding over the full material thickness.

In other embodiments, it is possible for the foil layers forming the housing shell, in particular the metal foil layers, to be wound in such a way that the edge area of the spirally wound foil ribbon is flush. In a range from this flush finish, a weld can be made to a metal disc or metal cap on the end face of the housing, for example by laser welding at the seam.

With regard to the welding of the housing shell wound from foil to the housing end faces, the method is characterized in a preferred manner by at least one of the following additional features:
a. Welding is carried out by laser welding;
b. Welding is carried out in such a way that a laser beam first penetrates the side wall of the metal cap before it hits the foil layers of the housing shell;
c. At least one of the end faces of the housing is formed by a metal cap with a circumferential depression as described above, the depression being bounded on the outside by the side wall of the cap.

Preferably, the aforementioned features a. and b., and preferably the aforementioned features a. to c. are realized in combination with one another.

The circumferential depression of the metal cap according to the aforementioned feature c. has an outer first depression side (the inner side of the side wall of the cap) and an inner second depression side, which delimit the circumferential depression on both sides thereof.

The circumferential depression in the metal cap provides a very advantageous way of applying a welding beam, in particular a laser beam, in such a way that the welding beam penetrates the side wall of the end face cap and welds the foil layers that form the housing shell to the circumferential side wall of the cap. This type of welding, which starts at the rigid metal material of the end face element and welds the foil layers starting from the rigid metal material, has proven to be advantageous.

In preferred embodiments of the method, at least one of the following additional features a. and b. is provided:
a. The first and/or the second housing end face of the energy storage cell are formed by a round metal disc or a metal cap comprising a round bottom and a circumferential side wall, wherein after the winding of the electrode-separator assembly, the first and/or the second winding end face are welded to the round metal disc or the metal cap before the housing shell of the energy storage cell is formed;
b. To form the first and/or the second housing end face of the energy storage cell, at least one contact element, optionally including a separate electrical conductor fixed to the contact element, is welded to the first and/or the second winding end face before the housing shell of the energy storage cell is formed, the contact element preferably being electrically insulated from the metal disc or cap forming the first housing end face or from the metal disc or cap forming the second housing end face.

In a preferred manner, the aforementioned features a. and b. are realized in combination with each other, whereby on one side of the energy storage cell, one winding end face is preferably in direct contact with the metal disc or cap forming the housing end face. On the other side, in addition to the metal disc or cap forming the end face of the housing, a contact element is provided to which the corresponding winding end face is connected.

To simplify the contacting of the winding end faces with the metal disc or the metal cap or the contact element, the following additional feature is provided in preferred embodiments:
a. Before welding the winding end faces of the electrode-separator assembly to the round, in particular circular, metal disc and/or to the metal cap and/or to the contact element, the edge region of the current collector, which may protrude from the winding end face on the respective side of the electrode-separator assembly and is free of electrode material, is bent in the direction of a central axis of the electrode-separator assembly.

As already explained above in connection with the energy storage cell, it may be provided that the metal disk or the metal cap forming an end face of the housing or, if applicable, the contact element have an aperture or recess. This aperture or recess can be used during assembly of the energy storage cell to introduce an electrolyte liquid into the interior of the energy storage cell in order to impregnate the electrode-separator assembly with it. The aperture or recess can then be closed, for example using a blind rivet.

Advantageously, the method of manufacturing the energy storage cell also uses at least one insulating means to prevent a short circuit between the electrodes of the cell. Preferably, this insulating means is placed between a contact element and the metal disk or cap forming the respective housing end face of the cell.

For further details on this insulating means, please refer to the description above. In particular, the insulating means can be placed after the winding end faces have been connected to the metal disks or caps forming the housing ends or, if necessary, with a contact element. Only then are the foil layers wound to form the housing shell.

For example, an annular insulating material or insulating tape that is attached to the edge of the winding in the region of the end face of the housing to be insulated is suitable for this purpose.

In a preferred embodiment of the method, the foil layers, in particular the metal foil layers forming the housing shell, are bonded together during the method. For this purpose, the metal foil ribbon or a corresponding section of the metal foil ribbon, which is provided for forming the housing shell, can be provided in advance with an adhesive layer, which is sprayed or squeegeed on, for example. This can be a liquid adhesive, a hot-melt adhesive or a thermoplastic adhesive. If a thermoplastic adhesive is used, the housing shell can be sealed afterwards in particular by curing the adhesive. With regard to this adhesive, reference is also made to the above explanations in connection with the energy storage cell.

Further features and advantages of the invention are shown in the following description of examples in conjunction with the drawings. The individual features can be realized individually or in combination with each other.

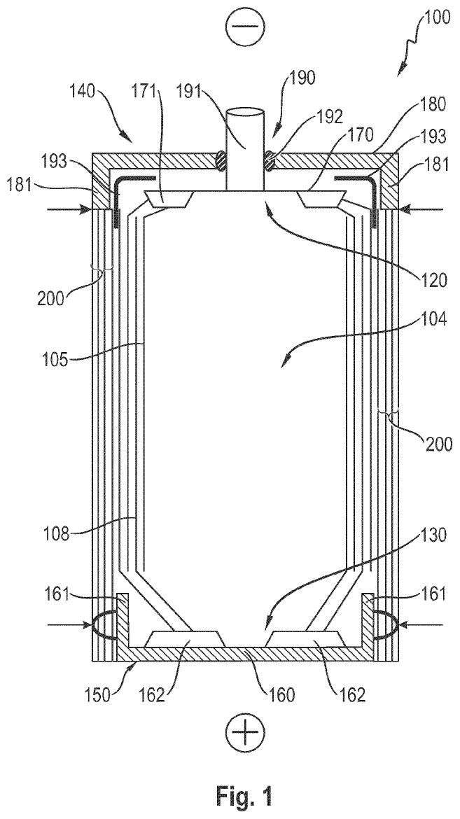

FIG. 1 shows a preferred embodiment of an energy storage cell 100. In the center of the cell is an electrode-separator assembly 104, which is in the form of a winding of electrode ribbons 105, 108 and ribbon-shaped separators.

The electrode-separator assembly 104 in the form of a winding is arranged axially within the energy storage cell 100. The electrode-separator assembly 104 comprises a first winding end face 120 and a second winding end face 130. The first winding end face 120 is located in the region of the first housing end face 140. The second winding end face 130 is located in the region of the second housing end face 150. For example, the negative pole of the cell is located in the region of the first housing end face 140 and, correspondingly, the positive pole of the cell is located in the region of the second housing end face 150.

The electrode-separator assembly 104 is formed in such a way that the electrode ribbons 105, 108 each have a longitudinal edge which is not coated with electrode material. These free longitudinal edges of the electrode ribbons 105, 108 each protrude from the electrode-separator assembly 104 at the opposite winding end faces 120, 130. In the example illustrated here, the uncoated edge of the anode current collector of the negative electrode 105 protrudes from the first winding end face 120. The uncoated edge of the cathode current collector of the positive electrodes 108 protrudes from the second winding end 130. Electrical contacting of the electrodes takes place via these edge regions of the current collectors. For this purpose, a metal cap 160 is provided on the second winding end face 130, which is provided with a circumferential side wall 161. The metal cap 160 is provided with a plurality of beads 162, which facilitate electrical contacting with the cathode current collector by welding. The metal cap 160 also forms the second end face 150 of the housing.

A metal contact element 170 is arranged in the region of the first winding end 120, which is in the form of a metal disk with several beads 171. Here too, electrical contact is made with the edge area of the anode current collector that is free of electrode material by means of welding. The first housing end 140 is formed on this side by a metal cap 180 with a circumferential side wall 181. In the center of the metal cap 180 there is a pole bushing 190 through which a pole stud 191 is guided, which is electrically insulated from the metal cap 180 by an insulating means 192, for example an insulating ring. The pole stud 191 is in electrical contact with the contact element 170, so that the anodic potential is conducted to the outside via the pole stud 191.

An insulating means 193, for example a circumferential insulating ring or a circumferential insulating tape, is placed between the contact element 170 and the upper edge of the electrode-separator assembly on this side of the cell on the one hand and the metal cap 180 on the other hand.

According to the invention, the housing shell 200 of the energy storage cell 100 in this embodiment is formed by a multilayer metal foil wound on the electrode-separator assembly 104. In this example embodiment, the metal foil forming the housing shell 200 is a continuous winding of the metal foil ribbon which forms the cathode current collector of the positive electrode 108 and which is not coated with electrode material.

To produce the housing shell 200, the electrode-separator assembly 104 is first wound onto a winding machine in a manner known per se. A ribbon-shaped separator is provided between each of the electrode ribbons. Viewed from the inside to the outside, one electrode ribbons runs out first and the coating of the other electrode ribbon runs out at the same time or somewhat later, whereby the ribbon-shaped separators and the current collector of the other electrode ribbon are continued. After two further turns, for example, the ribbon-shaped electrode-separator assemblies also end and thus form the end of the winding of the electrode-separator assembly. However, the current collector of the other electrode ribbons remains.

The winding end contacts are now made on both sides of the electrode-separator assembly with a metal cap or a metal disk or a contact element. For this purpose, a cut is made into the remaining current collector ribbon, for example to make it easier to fit the metal cap 160. To elevate the accuracy of fit when attaching the cap 160 and the contact element 170, the free edge areas of the spirally wound current collectors, which protrude from the electrode-separator assembly on both winding end faces, can be bent in the direction of the center of the winding beforehand. After welding on the cap 160 and the contact element 170, the winding of the remaining current collector ribbon is continued so that these metal foil layers form the housing shell 200.

In the example illustrated in FIG. 1, the cathode current collector ribbon or the metal foil forming the housing shell 200 is wound in such a way that the metal foil rests on the outer side of the circumferential side wall 161 of the metal cap 160 in the region of the second housing end 150. In the region of the first housing end 140, the edge of the metal foil forming the housing shell 200 closes flush in such a way that the metal cap 180 can sit with its circumferential side wall 181 on this flush closure of the edge of the metal foil forming the housing shell 200. In the region of the second housing end 150, the metal foil layers forming the housing shell 200 are fixed and sealed by laser welding over the full material thickness. In the region of the first housing end 140, laser welding takes place at the seam between the flush edge of the housing shell 200 and the opening edge of the side wall 181 of the cap 180. The arrows in FIG. 1 indicate the welding attachment points.

In preferred embodiments of the energy storage cell 100, the metal cap 160 on the second end face 150 may be formed of aluminum or an aluminum alloy. The cathode current collector is also preferably formed of aluminum or an aluminum alloy. The contact element 170 on the first end face 140 is preferably formed of copper or a copper alloy. The anode current collector is also preferably formed of copper or a copper alloy.

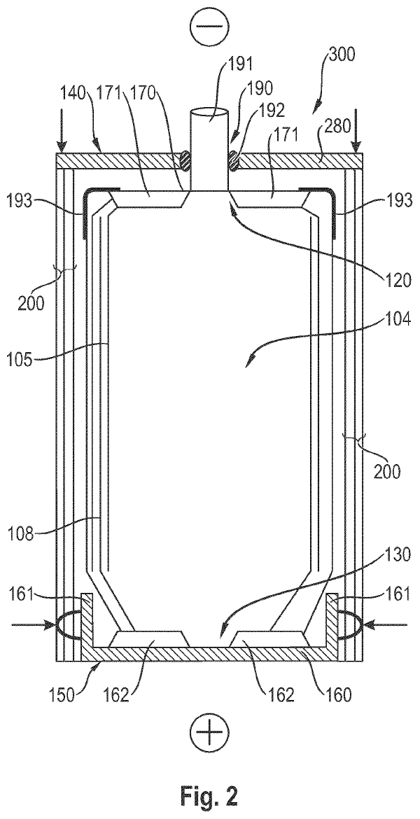

FIG. 2 shows a further embodiment of an energy storage cell 300, which is largely comparable with the embodiment of the energy storage cell 100 of FIG. 1. The corresponding elements are therefore provided with the same reference numbers and reference is made in this context to the description of FIG. 1.

In contrast to the embodiment of FIG. 1, the housing shell 200 of the energy storage cell 300 is not formed by a continuous current collector ribbon, but by a separate metal foil which is wound onto the electrode-separator assembly 104.

In the embodiment illustrated in FIG. 2, the metal foil forming the housing shell 200 has a slightly greater width than the electrode ribbons and ribbon-shaped separators forming the electrode-separator assembly 104. The wound housing shell 200 therefore protrudes somewhat further beyond the first winding end face 120 with the contact element 170 welded thereto in the region of the first housing end face 140 than in the embodiment illustrated in FIG. 1. In adaptation thereto, the first end face 140 of the energy storage cell 300 is terminated by a metal disk 280. To connect the metal disc 280 to the edge of the wound housing shell 200, laser welding can be performed from above in the corresponding edge-side regions, as indicated by the arrows.

In the region of the second housing end 150, the metal foil layers forming the housing shell 200 are joined and sealed by laser welding over the entire material thickness of the housing shell 200, as in the embodiment of the energy storage cell 100 in FIG. 1.

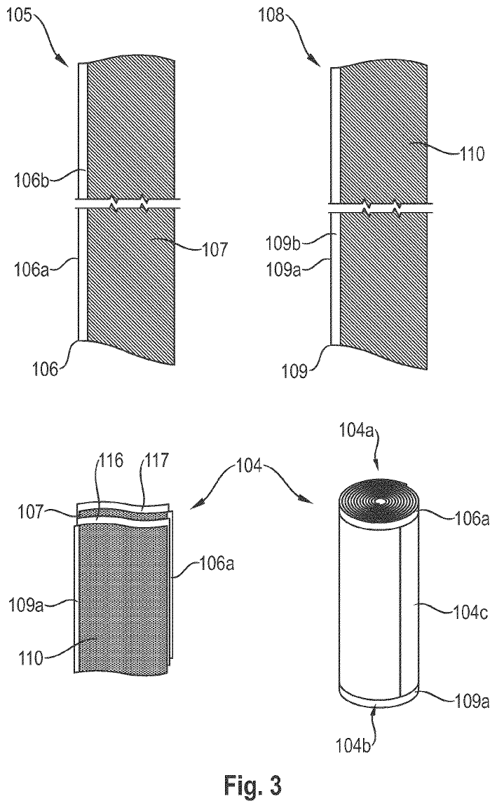

A preferred structure of the electrode-separator assembly 104 is illustrated with reference to FIG. 3. The assembly 104 comprises the ribbon-shaped anode 105 with the ribbon-shaped anode current collector 106, which has a first longitudinal edge 106a and a second longitudinal edge parallel thereto. The anode current collector 106 is a foil of, for example, copper or nickel. This comprises a strip-shaped main region, which is loaded with a layer of negative electrode material 107, and a free edge strip 106b, which extends along its first longitudinal edge 106a and which is not loaded with the electrode material 107.

Furthermore, the ribbon-shaped electrode-separator assembly 104 comprises the ribbon-shaped cathode 108 with the ribbon-shaped cathode current collector 109, which has a first longitudinal edge 109a and a second longitudinal edge parallel thereto. The cathode current collector 109 is in particular an aluminum foil. It comprises a strip-shaped main region, which is loaded with a layer of positive electrode material 110, and a free edge strip 109b, which extends along its first longitudinal edge 109a and which is not loaded with the electrode material 110. Both electrodes are shown individually in an unwound state.

The anode 105 and the cathode 108 are arranged offset from each other within the electrode-separator assembly 104, so that the first longitudinal edge 106a of the anode current collector 106 protrudes from the first terminal end face 104a and the first longitudinal edge 109a of the cathode current collector 109 protrudes from the second terminal end face 104b of the electrode-separator assembly 104. The offset arrangement can be seen in the illustration at the bottom left. The two ribbon-shaped separators 116 and 117, which separate the electrodes 105 and 108 from each other in the winding, are also shown there.

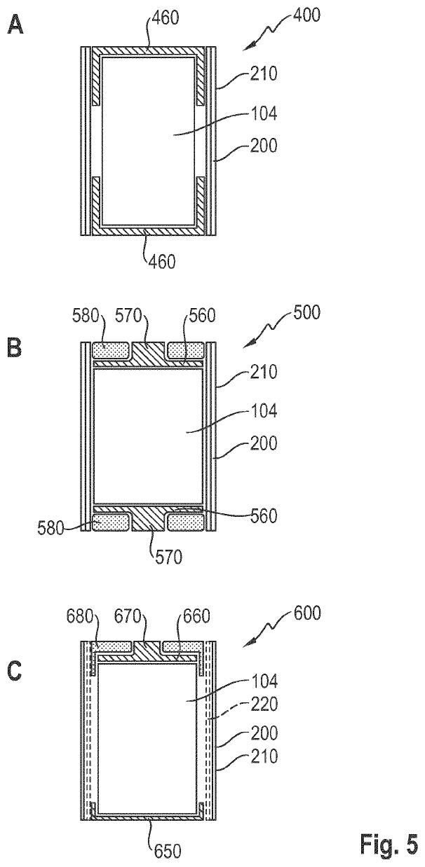

In the illustration at the bottom right, the electrode-separator assembly 104 is shown in wound form, as it can be used in an energy storage cell according to FIG. 1 or FIG. 2 or in an energy storage cell according to FIGS. 5A-C explained below. The electrode edges 106a and 109a protruding from the end faces 104a and 104b are clearly visible. The winding shell 104c is formed, for example, by several turns of the ribbon-shaped separators 116, 117 or, for example, by a plastic foil.

Such an electrode-separator assembly 104 in the form of a winding is expediently produced on a winding machine. To facilitate contact with the components of the energy storage cell on the winding end face, the uncoated edge regions of the electrode ribbons 105, 108 are preferably placed specifically in the direction of the winding core.

The metal disk or the metal cap 160 or a contact element 170, via which contact is made with the electrodes 105, 108, are preferably welded onto the winding end faces on the winding machine. This can be done in particular in the region of the beads 162, 171 advantageously present on these elements, i.e. on the metal disk or the metal cap or the contact element.

Advantageously, these components on the winding end have a central opening that can be used to guide these elements on a winding needle during positioning in the winding machine. This central opening can also be used for dosing an electrolyte.

In the case of a metal cap with a circumferential side wall, this cap is advantageously positioned so that the height of the circumferential side wall is just below the width of the uncoated region of the respective electrode ribbon. The diameter of the circumferential side wall is comparable to the diameter of the winding. The height of the side wall is comparable to the uncoated region of the electrodes. The height of the side wall can be between 1.5 and 2.5 mm, for example.

The beads 162 of the metal cap 160 or the beads 171 of the contact element 170 can be arranged in a star shape, for example, three beads per cap 160 or per contact element 170. In the center of the cap 160 or the contact element 170, there can be an aperture or a hole that can be used for passing a winding needle through and thus for positioning these elements on the winding end faces.

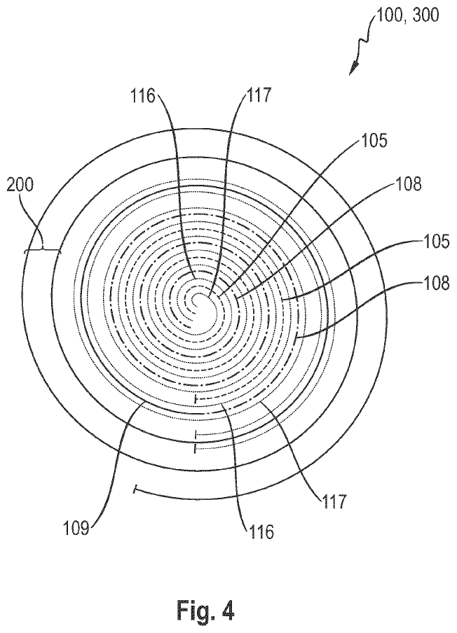

FIG. 4 illustrates the structure of the electrode-separator assembly 104 with the housing shell wrapped around it as a cross-sectional view of an energy storage cell 100, 300. In the center of the spiral structure, the winding starts with a first ribbon-shaped separator 117, a first electrode ribbon, for example the negative electrode ribbon 105, a second ribbon-shaped separator 116 and the second electrode ribbon, for example the positive electrode ribbon 108. After a plurality of turns, the negative electrode ribbon 105 ends first. In approximately the same region, the electrode material coating of the positive electrode ribbon 108 ends, with the uncoated cathode current collector 109 and the ribbon-shaped separators 116 and 117 continuing for a few turns. Then the ribbon-shaped separators 116 and 117 also end, so that only the cathode current collector 109 continues for several turns. These last turns of the cathode current collector 109 alone form the housing shell 200. In this embodiment, the housing shell 200 is thus formed by an aluminum foil, provided that the cathode current collector 109 is an aluminum foil.

In a similar way, the anode current collector, which consists of copper foil, for example, can be used to form the housing shell.

In other embodiments, a separate foil may be used to form the housing shell 200, which may be a metal foil or a plastic foil or a combination of both. When manufacturing the housing shell 200, the metal foil can therefore come directly from the electrode windings as an uncoated current collector or be fed separately within the winding machine. It is thus either directly connected to the electrode potential or already insulated.

The foil for forming the housing shell 200, in particular the metal foil for forming the housing shell 200, can be wound with the same or unequal thickness until the maximum outer diameter of the energy storage cell is reached. This foil forms the actual outer surface of the cell housing and replaces a housing cup provided in conventional energy storage cells.

Advantageously, the winding machine can control the position of the overlap of the electrode ribbons and the ribbon-shaped separators. This makes it possible for the foil, in particular the metal foil, to be moved further towards the center when forming the housing shell of the end face. In this way, different structures of the housing shell 200 are possible. For example, if the housing shell 200 is formed exclusively from an aluminum foil, in particular by continuing the cathode current collector, the foil material can be moved back and forth between the anode side and the cathode side so that the end-side regions of the housing shell are formed thinner. In a corresponding manner, the housing shell can be formed with a copper foil, which is used in particular as a continuous section of the anode current collector for the winding of the housing shell.

In other embodiments, the housing shell can be formed of different foils, for example of different metal foils, for example of an aluminum foil and a copper foil.

If necessary, the current collector foils can be cut to shape in the machine or in an upstream machine, for example if a wider foil needs to be narrowed at the end faces. The current collector foil or another foil that forms the housing shell can be cut using a laser, a punch or a shear cut, for example.

During the winding of the foil forming the housing shell, the first or, if applicable, all layers can be welded to the elements forming the housing end faces, i.e. in particular a metal cap or a metal disk.

These methods are used to form a winding body with a fixed outer surface and housing end terminations. Electrolyte can be dosed through any holes or apertures in the end elements of the housing, which are also used for the winding needles. The apertures or holes can later be closed with a blind rivet, for example.

With particular advantage, the winding layers that form the housing shell 200 are glued, which ensures the tightness of the housing shell. Standard adhesive, e.g. liquid adhesive, can be used for this purpose. Alternatively, a plastic can be sealed in, for example. The corresponding sections of the foil ribbons can be pre-coated for such a seal. For example, if the housing shell 200 is formed by a terminal section of the current collector of an electrode ribbon, this terminal section, for example the last few centimeters of the current collector ribbon, can be coated directly with a thermoplastic so that a seal can later be made over this thermoplastic.

A conventional energy storage cell with a form factor of 21700 generally has a housing wall thickness of 0.25 mm and is made of nickel-plated steel, for example. In order to insert an electrode-separator assembly or the electrode winding into the housing cup, a clearance of approx. 0.2 mm in diameter is required, which remains unused for the electrode material. In the energy storage cell with the wound housing shell, this unused space can be fully utilized. It is even possible that, in order to achieve a particular stability of the housing shell in the cell, the wall thickness of the foil layers forming the housing shell is higher than the usual wall thickness of 0.25 mm in a conventional cell, without the capacity of the resulting cell decreasing. For example, the wall thickness of the energy storage cell can be up to 0.35 mm, for example formed by 20 layers of aluminum foil, without the diameter of the cell increasing in comparison with a conventional energy storage cell and without the capacity being lower.

The assembly of a conventional energy storage cell, including the upstream production of the electrode-separator assembly and the cell assembly using a housing cup, usually accounts for about one third of the total production costs, of which about one third is attributable to the production of the electrode-separator assembly. Since the production of the energy storage cell eliminates the line for cell assembly, production costs can thus be significantly reduced, even if the winding process has to be adapted to the formation of the housing shell with a foil.

As an alternative to the direct contacting of the electrode ribbons via the flat end face elements of the energy storage cell illustrated in FIGS. 1 and 2, i.e. in particular directly via a metal disk or cap on the end face of the housing or directly via a flat contact element (contact plate design), metal contact strips can also be used for contacting the electrodes in a manner known per se. It is preferable if one of the electrodes, for example the cathode, is contacted via the flat contacting of the spiral edge of the uncoated cathode current collector protruding from the respective winding end face and the anodic side of the electrode-separator assembly is contacted via a metallic contact strip. In particular, this contact strip can be welded perpendicular to the running direction of the corresponding electrode strip on a free section of the strip-shaped current collector that is not loaded with electrode material and protrude from the winding on the corresponding winding end face and be used for contacting.

The size or form factor of the energy storage cells is in principle not limited. Preferably, the height of the energy storage cell, which is designed as a cylindrical round cell, is in a range from 50 mm to 150 mm. Its diameter is preferably in a range from 15 mm to 60 mm. Cylindrical round cells with these form factors are suitable for supplying power to electric drives in motor vehicles. However, smaller cylindrical round cells or button cells, for example, can also easily be produced according to the principle of the invention.

In addition to metal foils, other ribbon-shaped substrates such as metallic or metallized nonwovens or open-pored metal foams or expanded metals can in principle also be used as current collectors, although in this case the preferred embodiment of the cell described, in which the housing shell is formed by a terminal section of one of the current collectors, is generally not suitable. However, the embodiment in which the housing shell is formed by a separate foil can also be readily realized with such other ribbon-shaped substrates.

FIG. 5 illustrates in sub-figures A, B and C further possible embodiments 400, 500 and 600 of an energy storage cell. The energy storage cells 400, 500, 600 each comprise a winding-shaped electrode-separator assembly 104. In contrast to the embodiments of an energy storage cell illustrated with reference to FIGS. 1 and 2, the housing shell 200 of the energy storage cells 400, 500 and 600 is at least partially formed by a plastic foil.

In the energy storage cell 400 shown in FIG. 5A, the electrical connection of the electrodes of the electrode-separator assembly 104 is realized by two metal caps 460 located at the respective end faces of the energy storage cell 400. After completion of the winding-shaped electrode-separator assembly 104, these metal caps 460 are electrically connected, in particular welded, to the current collector ribbons of the electrodes forming the respective end faces of the winding. A plurality of plastic foil layers 210 are then wound over the outer circumference of the electrode-separator assembly 104 to form the housing shell 200. The housing can be sealed by welding the plastic foil layers 210 to the end face caps 460.

FIG. 5B shows a further embodiment of an energy storage cell 500. Here, the end faces of the electrode-separator assembly 104 are electrically contacted with metal components 560, each of which covers the end faces of the electrode-separator assembly and at the same time forms a pole pin 570. The housing shell 200 is formed by plastic foil layers 210, which are wrapped around the outside of the electrode-separator assembly 104. A plastic encapsulation 580 or a corresponding perforated plastic disk can be provided around the respective pole pin 570, which seals the end faces of the energy storage cell 500 flush with the outside in each case.

The embodiment of an energy storage cell 600 illustrated in FIG. 5C has a housing shell 200, which is formed in the inner region by several layers of a metal foil 220 and in the outer region by several layers of a plastic foil 210. For electrical contacting of the electrodes, a metal cap 650 is provided on the lower end face of the electrode-separator assembly 104 in this embodiment and a metal component 660 with an integrally formed pole pin 670 is provided on the upper end face of the electrode-separator assembly 104. A circumferential insulating element 680, in particular a plastic encapsulation, surrounds both the outer edge of the metal component 660 and the upper edge of the electrode-separator assembly in a range from its end face in order to electrically insulate the metal component 660 from the other components of the energy storage cell 600. At the same time, the insulating element 680 closes the upper end face of the energy storage cell 600 flush.

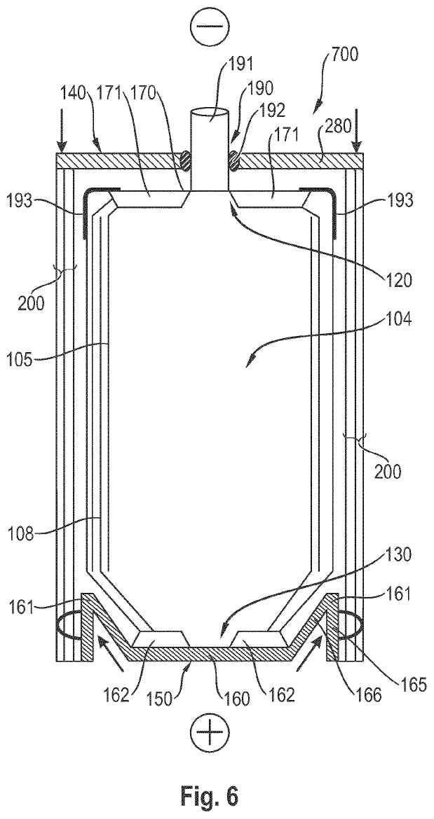

FIG. 6 shows a further advantageous embodiment of the energy storage cell 700. The energy storage cell 700 is largely similar to the embodiment of the energy storage cell 300 illustrated in FIG. 2. With regard to most of the features described, reference is therefore made to the description of FIG. 2.

Compared to the embodiment of the energy storage cell 300 according to FIG. 2, the end face 150 of the energy storage cell 700, which forms the positive pole of the cell, has a slightly different design. Namely, the metal cap 160 has a circumferential depression in its edge region, which is bounded on the outside by the side wall 165 of the cap 150 and on the inside by the beveled wall 166. The bounding walls 165, 166 form a channel or groove, as it were, in the outer edge region of the metal cap 160. This cavity formed here can be used to position a laser beam, indicated by the two slanted arrows, in such a way that the foil layers forming the housing shell 200 are welded on through the side wall 165. This procedure for welding the housing shell 200 to the end face of the cell has proven to be advantageous and practicable.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: An energy storage cell, comprising:
a cylindrical housing closed in a liquid-tight manner, the cylindrical housing comprising a first housing end face, a second housing end face, and a housing shell;
an electrode-separator assembly arranged in the housing the electrode-separator assembly being in the form of a cylindrical winding formed of electrode ribbons and at least one ribbon-shaped separator, wherein the winding has a first terminal winding end face, a second terminal winding end face, and a winding shell;
wherein the electrode-separator assembly is arranged axially in the housing so that the first winding end face points in a direction of the first housing end face and the second winding end face points in a direction of the second housing end face;
wherein the housing shell of the energy storage cell is formed of at least one spirally wound foil and comprises at least two layers of the foil.

2: The energy storage cell of claim 1, wherein at least one of:
the electrode-separator assembly comprises a positive polarity electrode ribbon comprising a ribbon-shaped cathode current collector having a first longitudinal edge and a second longitudinal edge parallel thereto, the cathode current collector being coated on both sides with a positive electrode material;
the electrode-separator assembly comprises a negative polarity electrode ribbon comprising a ribbon-shaped anode current collector having a first longitudinal edge and a second longitudinal edge parallel thereto and coated on both sides with a negative electrode material; and/or
the at least one ribbon-shaped separator electrically insulates the oppositely polarized electrode ribbons from one another.

3: The energy storage cell of claim 2, wherein at least one of:
the spirally wound foil forming the housing shell is a spirally wound terminal section of the ribbon-shaped cathode current collector that is not coated with the positive electrode material;
the spirally wound foil forming the housing shell of the energy storage cell is a spirally wound terminal section of the ribbon-shaped anode current collector that is not coated with the negative electrode material; and/or
the ribbon-shaped cathode current collector and the ribbon-shaped anode current collector have a constant width over their entire length.

4: The energy storage cell according to claim 1, wherein at least one of:
the spirally wound foil forming the housing shell of the energy storage cell is a spirally wound foil ribbon wound onto the winding shell of the electrode-separator assembly;
b. the winding shell of the electrode-separator assembly is formed of an electrically insulating material;
the foil ribbon has an essentially constant width over its entire length; and/or
the foil ribbon has a greater width than the ribbon-shaped cathode current collector and/or the ribbon-shaped anode current collector.

5: The energy storage cell according to claim 1, wherein at least one of:
the spirally wound foil that forms the housing shell of the energy storage cell consists of aluminum or an aluminum alloy;
the spirally wound foil that forms the housing shell of the energy storage cell consists of copper or nickel or a copper alloy or a nickel alloy; and/or
the spirally wound foil that forms the housing shell of the energy storage cell consists of plastic.

6: The energy storage cell according to claim 1, wherein the foil layers, which form the housing shell of the energy storage cell, are bonded together by an adhesive layer arranged between the layers.

7: The energy storage cell according to claim 1, wherein at least one of:
the ribbon-shaped current collectors have at least one free section not coated with the electrode material to which a metal contact strip is welded; and/or
the metal contact strip welded to the current collector protrudes from one of the winding end faces.

8: The energy storage cell according to claim 1, wherein at least one of:
the first housing end face of the energy storage cell is formed of a round metal disc or of a metal cap comprising a round bottom and a circumferential side wall;
the metal disc or cap forming the first housing end face is connected to the housing shell by welding;
the second housing end face of the energy storage cell is formed by a round, in particular circular, metal disc or a metal cap comprising a round, in particular circular, bottom and a circumferential side wall; and/or
d. the metal disc or cap forming the second housing end face is connected to the housing shell by welding.

9. The energy storage cell of claim 8, wherein the metal contact strip welded to the current collector is connected directly to the metal disc or cap forming the first end face of the housing or to the metal disc or cap forming the second end face of the housing.

10: The energy storage cell of claim 8, wherein at least one of:
an electrical contact pole is led through the first and/or through the second housing end face, wherein the contact pole is electrically insulated from the respective housing end face and electrically connected to one of the ribbon-shaped current collectors directly or via a metal conductor; and/or
one of the ribbon-shaped current collectors is electrically connected directly or via a metal conductor to the metal disc or cap forming the first housing end face or to the metal disc or cap forming the second housing end face.

11: The energy storage cell according to claim 2, wherein at least one of:
the ribbon-shaped anode current collector comprises a main region loaded with a layer of the negative electrode material and a free edge strip that extends along its first longitudinal edge and is not loaded with the negative electrode material;
the ribbon-shaped cathode current collector comprises a main region loaded with a layer of positive electrode material and a free edge strip extending along its first longitudinal edge that is not loaded with the positive electrode material; and/or
the electrode ribbons are arranged within the electrode-separator assembly in such a way that:
the first longitudinal edge of the anode current collector or the first longitudinal edge of the cathode current collector protrudes from one of the terminal winding end faces, or
the first longitudinal edge of the cathode current collector protrudes from one terminal winding end face and the first longitudinal edge of the anode current collector protrudes from the other terminal winding end face of the electrode-separator assembly.

12: The energy storage cell of claim 11, wherein one of the ribbon-shaped current collectors is electrically connected directly to the metal disc or cap forming the first housing end face or to the metal disc or cap forming the second housing end face, wherein the first longitudinal edge of the respective current collector rests directly on the metal disc or the bottom of the cap and is connected thereto by welding.

13: The energy storage cell of claim 11, wherein at least one of:
the first longitudinal edge of the anode current collector and/or the first longitudinal edge of the cathode current collector protrudes from one of the terminal winding end faces and has a spiral shape; and/or
at least the outer turn of the first longitudinal edge is bent in the direction of a central axis of the electrode-separator assembly.

14: The energy storage cell according to claim 8, wherein at least one of:
the energy storage cell comprises at least one contact element connected to the first longitudinal edge of the cathode current collector or the anode current collector by welding and via which the respective current collector is electrically connected to the metal disc or cap forming the first housing end face or to the metal disc or cap forming the second housing end face;
the contact element sits flat on the first longitudinal edge of the cathode current collector or the first longitudinal edge of the anode current collector;
the contact element comprises a first element which sits flat on the first longitudinal edge of the current collector protruding from the first or the second terminal end face and which extends parallel to the respective winding end face, and further comprises a second element which adjoins the first element at an angle and via which the first element is electrically connected to the metal disc or cap forming the first housing end face or to the metal disc or cap forming the second housing end face;
the contact element is connected directly to the metal disc or cap forming the first housing end face or to the metal disc or cap forming the second housing end face; and/or
the contact element is in contact directly or via an electrical conductor with an electrical contact pole routed through the first and/or through the second housing end face.

15: The energy storage cell according to claim 8, further comprising at least one of:
the metal cap, has a circumferential depression in its edge region, which is bounded on the outside by the circumferential side wall of the metal cap; and/or
the circumferential side wall of the metal cap lies flat against the foil that forms the housing shell.

16: A method of manufacturing an energy storage cell according to claim 1, the method comprising:
producing, on a winding machine, the electrode-separator assembly; and
forming the housing shell by winding the foil.

17: The method according to claim 16, further comprising:
welding the housing shell to at least one of the housing ends.

18: The method of claim 17, wherein at least one of:
the welding is carried out by laser welding;
the welding is carried out in such a way that a laser beam first penetrates the side wall of the metal cap before it hits the foil layers of the housing shell; and/or
at least one of the end faces of the housing is formed by a metal cap with a circumferential depression, the depression being bounded on the outside by the side wall of the cap.
